(19) United States
(12) Patent Application Publication
(10) Pub. No.: US 2015/0038220 A1
(43) Pub. Date: Feb. 5, 2015

(54) ON-LINE PICTURE/VIDEO VOTING

(71) Applicant: Yury Kuznetsov, Glendale, CA (US)

(72) Inventor: Yury Kuznetsov, Glendale, CA (US)

(21) Appl. No.: 13/955,311

(22) Filed: Jul. 31, 2013

(51) Int. Cl. A63F 13/12

(52) U.S. Cl. CPC A63F 13/12
USPC 463/26

(57) ABSTRACT

A system providing posting of visual content, voting to determine popularity, and an associated self-funding rewards aspect of the system. The system uses a host website on which members of the public post visual content, and for which the members of the public are assessed fees for participating. Posted content is judged by a voting system in which the participants vote to indicate their preference based on posted visual content. At least some of the pool of funds collected from assessed fees is returned to those participants who win in the voting.

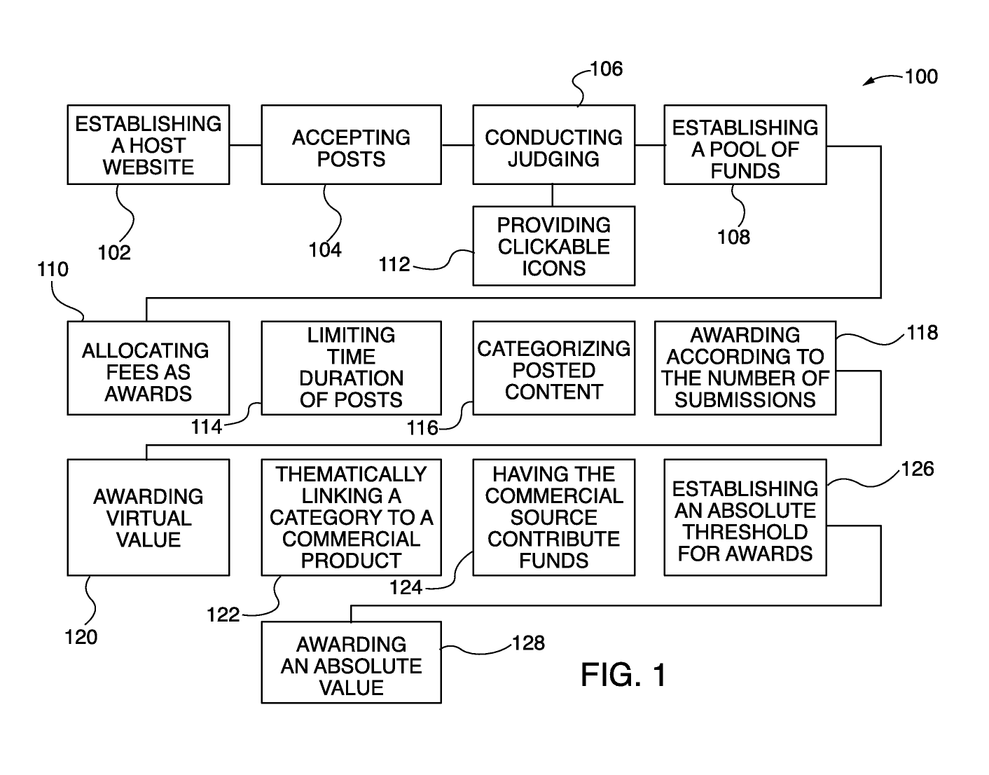

### CROSS REFERENCE TO RELATED APPLICATION

This application claims the benefit of the filing date under 35 USC 119(e) of the filing date of U.S. Provisional Application Ser. No. 61/829,520, filed May 31, 2013, the contents of which are incorporated herein.

### FIELD OF THE INVENTION

The present invention relates to an on-line contest, and more particularly, to a contest directed to user-created visual content such as still and moving images.

### BACKGROUND OF THE INVENTION

It has become popular for members of the public to post visual content they have created on-line, such as using YouTube® and other websites which accept donor still images and videos. In such venues, content is exposed to the public, but there is no element of voting to determine popularity of posted content, with a reward being awarded to winners. There exists room in the art for on-line contests featuring posted visual content, voting to determine popularity of competing content posts, and rewards for winners of voting.

### SUMMARY OF THE INVENTION

The present invention addresses the above stated need by providing a system providing posting of visual content, voting to determine popularity, and an associated self-funding rewards aspect of the system. The system uses a host website on which members of the public post visual content, and for which the members of the public are assessed fees for participating. Posted content is judged by a voting system in which the participants vote to indicate their preference based on posted visual content. At least some of the pool of funds collected from assessed fees is returned to those participants who win in the voting.

It is an object of the invention to establish an on-line system for posting, voting for, and rewarding popular posts of visual content.

Another object of the invention is that the pool of funds providing rewards be obtained from participants of the on-line system.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawing.

### BRIEF DESCRIPTION OF THE DRAWING

Various objects, features, and attendant advantages of the present invention will become more fully appreciated as the same becomes better understood when considered in conjunction with the accompanying drawing, which is a block diagram summarizing steps of a method of displaying, judging, and rewarding visual content posted on-line.

### DETAILED DESCRIPTION

According to at least one aspect of the invention, there is disclosed an on-line method 100 for displaying, judging, and rewarding visual content posted on-line. The method 100 includes establishing a host website 102, accepting posts of visual content on the host website by participating members of the public 104, conducting judging of visual content posted on the host website by polling the participating members and recording votes cast by polled participating members 106, establishing a pool of funds to fund awards payable to predetermined winners of cast votes by charging a fee to each participating member for each posting of visual content on the host website 108, and allocating a portion of collected fees as awards payable to predetermined winners of cast votes 110. Conducting judging comprises providing clickable icons which may be selected by voting participants by clicking on the icon 112. Each post of visual content is provided with one clickable icon. Voting is conducted by having each one of the participants click on the clickable icon associated with the posted visual content of his or her choice among the posted content. The number of clicks on the clickable icons for each submitted post of visual content is counted or recorded by a server maintained by the operator of the host website. Awards are made to one or more winners, based on the total number of votes, where a vote is generated when a participant clicks on one clickable icon for one example of posted content preferred by that participant. While it would be possible to limit the awards to a single award made to that participant collecting the single greatest number of votes, it is also possible to make awards to an increased number of winners. For example, a predetermined number of winners, such as ten, could be paid awards, with each award being greater in accordance with greater vote totals. In another example, an absolute or predetermined portion of the field of participants could be paid awards. Illustratively, the top ten percent of the vote getters could be paid awards.

The term “visual content” describes any creative works. As non-limiting examples, creative works may describe sounds, architecture, music, paintings, pictures, stories, written text, or anything else of original content.

In an example, the method may include limiting time duration of each post of visual content to a predetermined time interval 116. That is, a predetermined time interval such as a day, a week, a month, or even longer may be allowed for participants to submit postings and vote. After the week has terminated, votes from clicked icons are tallied, and awards are paid to the winners after a limited time window has closed. Payment of awards may initiate a subsequent round of submitting postings and voting. The method 100 may include categorizing posted visual content according to a plurality of categories, and paying awards to respective winners of each of the categories 116. Categories could be topics selected by the operator of the host website.

In the method, paying awards to winners comprises awarding relatively large awards to winners in categories according to the number of submissions of posted visual content 118. In this option, the greater the number of submissions, the greater the amount of awards paid to winners.

In the method 100, paying awards to winners may include awarding virtual value to the winners 120. That is, in place of sending a financial instrument such as a check to a winner, or in place of making an automated deposit to an account of a winner, an award paid to a winner may take the form of a credit to an account with a particular merchant, for example.

Where categories are established, at least one category may be thematically linked to a commercial product of a commercial source of the commercial product 122. Illustratively, a manufacturer of beverages may establish a category requiring that beverage products of the manufacturer be featured in posted visual content. This may be done as a promotion of the products of that manufacturer. In the method, and where a category is thematically linked to a commercial product, allocating a portion of collected fees as awards payable to predetermined winners of cast votes may be supplemented by having the commercial source contribute funds to the collected fees 124. Greater awards paid to the winner or winners of the category thematically linked to the commercial product may stimulate enhanced interest in the product of the manufacturer.

In the method, conducting judging may include establishing at least one predetermined absolute threshold in terms of votes garnered, for awarding funds to winners 126. Illustratively, a predetermined award may be paid to each participant who garners a predetermined number of votes, such as each winner of at least one hundred votes receiving a value instrument such as a store credit. The method may include awarding a predetermined absolute value to each winner 128. Illustratively, a winner who, for example, garnered one hundred votes may be paid a twenty dollar award. The twenty dollar award is an absolute value, as contrasted with a relative award, which could be a predetermined percentage of the pool of awards funds, for example.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An on-line method for displaying, judging, and rewarding creative works posted on-line, comprising:
establishing a host website;
accepting posts of creative works on the host website by participating members of the public;
conducting judging of creative works posted on the host website by polling the participating members and recording votes cast by polled participating members;
establishing a pool of funds to fund awards payable to predetermined winners of cast votes by charging a fee to each participating member for each posting of creative works on the host website; and
allocating a portion of collected fees as awards payable to predetermined winners of cast votes.

2. The on-line method of claim 1, wherein conducting judging comprises providing clickable icons which may be selected by voting participants by clicking on the icon, wherein each post of creative works has one clickable icon, and counting the number of clicks of the icon for each submitted post of creative works.

3. The on-line method of claim 1, further comprising limiting time duration of each post of creative works to a predetermined time interval.

4. The on-line method of claim 1, wherein conducting judging comprises providing a limited time interval for participants to vote by selecting the clickable icons, and awarding payments to the predetermined winners after the limited time interval has closed.

5. The on-line method of claim 1, further comprising categorizing posted creative works according to a plurality of categories, and paying awards to respective winners of each of the categories.

6. The on-line method of claim 1, further comprising paying awards to winners comprises awarding virtual value to the winners.

7. The on-line method of claim 5, wherein paying awards to winners comprises awarding relatively large awards to winners in categories according to the number of submissions of posted creative works, wherein the greater the number of submissions, the greater the awards.

8. The on-line method of claim 5, wherein at least one category is thematically linked to a commercial product of a commercial source of the commercial product.

9. The on-line method of claim 8, wherein allocating a portion of collected fees as awards payable to predetermined winners of cast votes comprises having the commercial source contribute funds to the collected fees.

10. The on-line method of claim 1, wherein conducting judging comprises establishing at least one predetermined absolute threshold for awarding funds to winners.

11. The on-line method of claim 10, wherein awarding funds to winners comprises awarding a predetermined absolute value to each winner attaining one of the predetermined absolute thresholds.
